(19) United States
(12) Patent Application Publication
(10) Pub. No.: US 2014/0236980 A1
(43) Pub. Date: Aug. 21, 2014

(54) Method and Apparatus for Establishing Association

(71) Applicant: Huawei Device Co., LTD, Shenzhen (CN)

(72) Inventor: Hai Peng, Wuhan (CN)

(73) Assignee: Huawei Device Co., LTD, Shenzhen (CN)

(21) Appl. No.: 14/261,128

(22) Filed: Apr. 24, 2014

Related U.S. Application Data
(63) Continuation of application No. PCT/CN2012/083424, filed on Oct. 24, 2012.

(30) Foreign Application Priority Data
Oct. 25, 2011 (CN) 201110329191.2

(51) Int. Cl. G06F 17/30

(52) U.S. Cl. CPC G06F 17/30259
USPC 707/758

(57) ABSTRACT

A method can be used with a mobile device. In response to an operation by a mobile device user, an image of a selected person in a picture displayed on the mobile device is determined. The picture includes more than one person. Corresponding information that matches the image of the selected person in the picture is searched for and in association between the image of the selected person in the picture and the corresponding information is established.

This application is a continuation of International Application No. PCT/CN2012/083424, filed on Oct. 24, 2012, which claims priority to Chinese Patent Application No. CN 201110329191.2, filed on Oct. 25, 2011, both of which are hereby incorporated by reference in their entireties.

### TECHNICAL FIELD

The present invention relates to the field of recognition and, in particular embodiments, to a method and an apparatus for establishing an association.

### BACKGROUND

Currently, many terminal or mobile devices (for example, cell phones) support an association function (for example, a function of associating an address book with photos in a cell phone), that is, associating and matching information.

For example, a contact in an address book is associated and matched with a photo file in an album of a cell phone, an associated photo in the album can be directly found according to a contact in the address book, and contact information of a corresponding contact can also be quickly found according to a photo in the album.

An existing function of associating an address book with photos adopts a manner of associating a contact with a file name of a photo, that is, adding a file name and a path of a photo into corresponding contact information. In this way, a function of associating a contact in an address book with a photo in an album is implemented.

### SUMMARY OF THE INVENTION

In a process of implementing embodiments of the present invention, the inventor finds that the prior art has at least the following problem. If multiple persons are present in a picture/photo, with the foregoing method, an association between an image of each person in the picture/photo and information of the person cannot be established.

Embodiments of the present invention provide a method and an apparatus for recognizing an associated picture, which can establish an association between an image of each person in a picture/photo of multiple persons and information of the person.

To achieve the foregoing objective, the embodiments of the present invention adopt the following technical solutions.

A method for establishing an association includes searching for information matching an image of a selected person and establishing an association between the found information matching the image of the selected person and the image of the selected person.

An apparatus for establishing an association includes a searching unit, configured to search for information matching an image of a selected person, and an association establishing unit, configured to establish an association between the found information matching the image of the selected person and the image of the selected person.

With the foregoing technical solutions, after an operation that a user selects an image of a certain person is detected, information matching the image of the selected person is searched for, and then an association between the information matching the image of the selected person and the image of the selected person is established. Compared with the prior art in which a picture only has one file name, the file name is the only basis for identifying the picture, and establishment of an association between specific information of each person in a picture of multiple persons and an image of the person is not supported, with the technical solutions, an association between an image of each person in a picture of multiple persons and information of the person can be established.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a flowchart of a method for establishing an association according to a first embodiment of the present invention;

FIG. 2 is a structural diagram of an apparatus for establishing an association according to a second embodiment of the present invention;

FIG. 3 is a flowchart of a method for establishing an association according to a third embodiment of the present invention;

FIG. 4 is a flowchart of a principle of facial recognition according to the third embodiment of the present invention;

FIG. 5 is a flowchart of another method for establishing an association according to the third embodiment of the present invention;

FIG. 6 is a diagram of an example of a photo adopted in the third embodiment of the present invention;

FIG. 7 is a flowchart of a method for establishing an association by using a picture/photo of multiple persons according to the third embodiment of the present invention; and

FIG. 8 is a structural diagram of an apparatus for establishing an association according to a fourth embodiment of the present invention.

### DETAILED DESCRIPTION OF ILLUSTRATIVE EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the embodiments to be described are a part rather than all of the embodiments of the present invention. All other embodiments obtained by a person of ordinary skill in the art based on the embodiments of the present invention without creative efforts shall fall within the protection scope of the present invention.

A method and an apparatus for establishing an association according to the embodiments of the present invention are described in detail in the following with reference to the accompanying drawings.

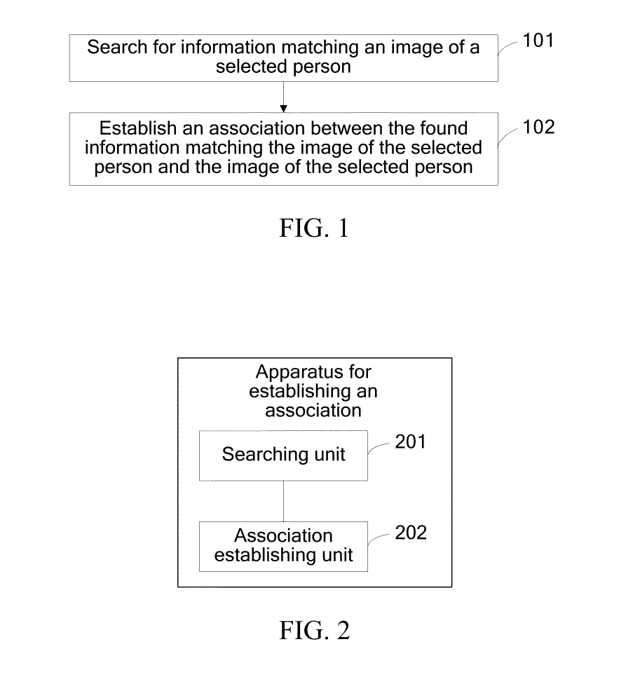

As shown in FIG. 1, an embodiment (Embodiment 1) of the present invention provides a method for establishing an association, which includes the following steps.

101: Search for information matching an image of a selected person.

102: Establish an association between the found information matching the image of the selected person and the image of the selected person.

An execution subject of this embodiment may be a mobile device or a terminal device (for example, a cell phone).

With the foregoing technical solution, after an operation that a user selects an image of a certain person is detected, information matching the image of the selected person is searched for, and then an association between the information matching the image of the selected person and the image of the selected person is established. Compared with the prior art in which a picture only has one file name, the file name is the only basis for identifying the picture, and establishment of an association between specific information of each person in a picture of multiple persons and an image of the person is not supported, with the technical solution provided in the embodiment of the present invention, an association between an image of each person in a picture of multiple persons and information of the person can be established.

As shown in FIG. 2, an embodiment (Embodiment 2) of the present invention provides an apparatus for establishing an association. This apparatus includes a searching unit 201 and an association establishing unit 202.

The searching unit 201 is configured to search for information matching an image of a selected person.

The association establishing unit 202 is configured to establish an association between the found information matching the image of the selected person and the image of the selected person.

With the foregoing technical solution, after an operation that a user selects an image of a certain person is detected, information matching the image of the selected person is searched for, and then an association between the information matching the image of the selected person and the image of the selected person is established. Compared with the prior art in which a picture only has one file name, the file name is the only basis for identifying the picture, and establishment of an association between specific information of each person in a picture of multiple persons and an image of the person is not supported, with the technical solution provided in the embodiment of the present invention, an association between an image of each person in a picture of multiple persons and information of the person can be established.

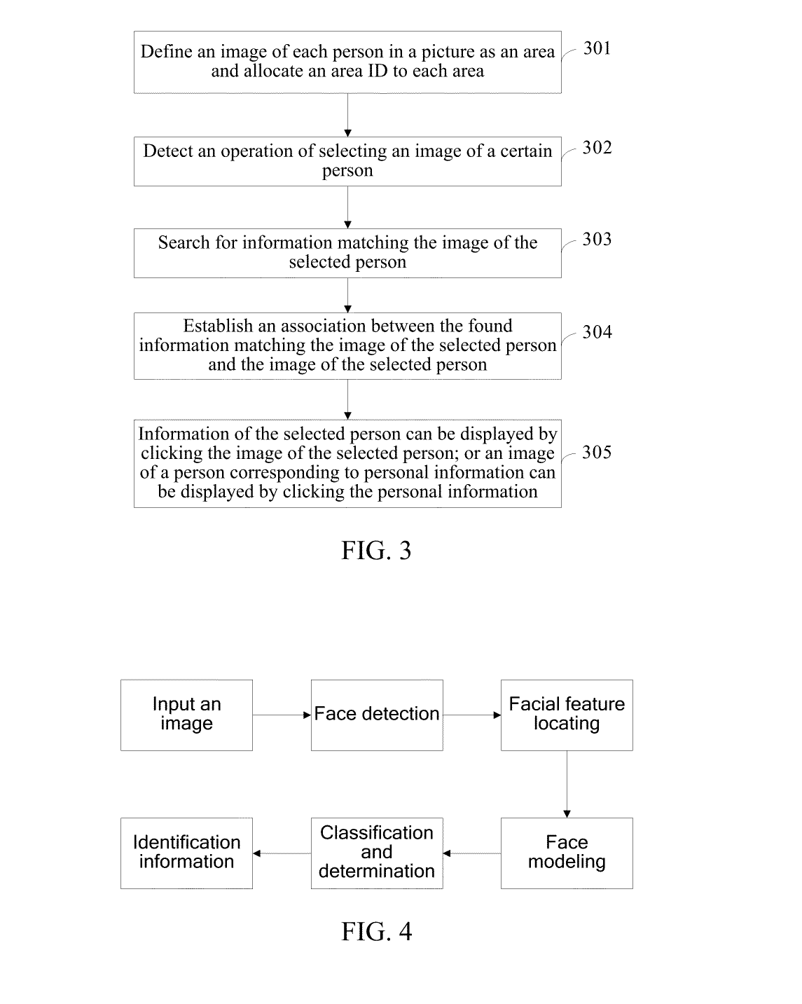

Based on the method according to Embodiment 1, as shown in FIG. 3, a certain embodiment (Embodiment 3) further provides a method for establishing an association. This third embodiment includes the following steps.

301: Define an image of each person in a picture/photo of multiple persons as an area and allocate an area ID to each area.

Specifically, the image of each person in the picture may be defined as an area by using a method of facial recognition.

Further, a principle of facial recognition is shown in FIG. 4, and facial recognition may be substantially categorized into the following aspects.

(1) Face detection includes detecting the existence of a face from different scenarios and determining a location of the face. A scenario on most occasions is complicated, and a location of a face is not known in advance. Therefore, whether a face exists in a scenario needs to be determined first, and if a face exists, a location of the face in an image is then determined. Factors, such as facial hair, cosmetics, lighting, noises, face tilting, changes of a face size and all types of shading, make face detection more complicated. A main objective of face detection is to find a face area in an entire input image, and divide the image into two parts: a face area and a non-face area, so as to lay a foundation for subsequent processing. This manner is used to determine a face area in the present invention.

(2) Face representation includes using a certain representation manner to indicate a detected face and a known face in a database. Common representation methods include a geometric characteristic (for example, a Euclidean distance, a curvature, or an angle), an algebraic characteristic (for example, a matrix eigenvector), a fixed characteristic template, an eigenface, moire topography, and the like.

(3) Face identification includes comparing and matching the detected face to be recognized with the known face in the database to obtain related information. The core of this process is to select a suitable face representation manner and a matching policy, and the architecture of a system is closely associated with a face representation manner. Generally, a comprehensive method or a method based on a characteristic is selected to perform matching. Obviously, a characteristic selected based on a side view is greatly different from a characteristic selected based on a front view.

(4) Expression analysis includes analyzing expression information (happy, sad, terrified, surprised, and the like) of the face to be recognized and classifying the expression information.

(5) Physical classification includes analyzing physical characteristics of the face to be recognized to obtain related information, such as race, age, gender and occupation. Obviously, this operation requires a large amount of knowledge and is generally rather difficult and complicated.

Currently, researches on facial recognition mainly focus on the first three aspects. A complete facial recognition system generally includes three steps: face detection and tracking, characteristic extraction and selection, and classification and determination.

302: Detect an operation of selecting an image of a certain person.

Specifically, in the picture, a facial recognition technology may be used to recognize a face area, each face area is allocated with an area ID, and the area IDs are saved. When a user selects an image of a certain person in the picture, which area ID selected by the user is known.

303: Search for information matching the image of the selected person.

Specifically, as an example, an image that matches the image of the selected person among images provided by a terminal is searched for, where the image that is matches the image of the selected person among the images provided by the terminal corresponds to to-be-associated information.

304: Establish an association between the found information matching the image of the selected person and the image of the selected person.

Specifically, an association is established between the to-be-associated information and a target area ID, where the to-be-associated information corresponds to the image that matches the image of the selected person among the images provided by the terminal, and the target area ID is an area ID of an area where the image of the selected person is located.

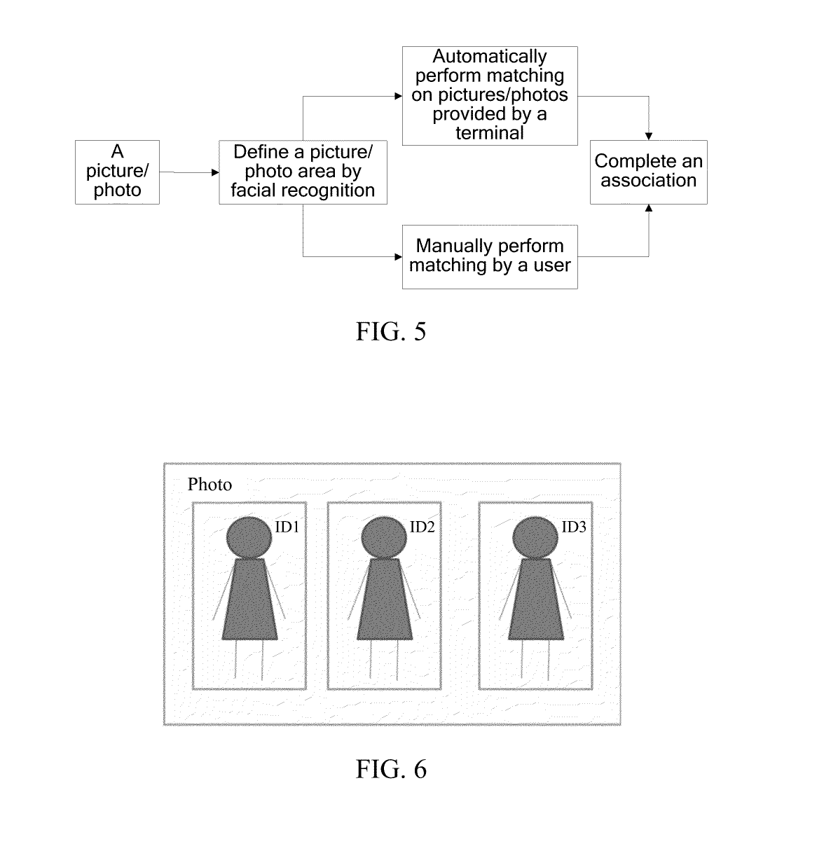

Further, referring to FIG. 5, two manners are available for establishing an association, that is, a terminal automatically establishes an association or a user manually sets an association.

As shown in FIG. 5, first, a picture to be associated is found in a terminal device (for example, a photo of multiple persons is prepared in a cell phone). A facial recognition technology is used to define face areas and non-face areas of the picture. Each face area is allocated with a different face area ID, that is, an area occupied by each face corresponds to an area ID; and then the area ID is saved. When a user selects a certain area, a system knows which area ID is selected by the user.

As shown in FIG. 6, there are three persons in a picture/photo, and an area scope of each person in the picture/photo respectively corresponds to an ID1, an ID2, and an ID3. When a user points to which person with a finger, which area ID is known accordingly.

Two manners are available for performing matching.

In one matching method, a terminal automatically establishes an association.

In a specific example, the terminal device is a cell phone, and when an image of a person in a picture/photo stored in the cell phone corresponds to information (the information is contact information) of the person in the picture/photo of multiple persons, matching a contact in an address book is automatically performed.

It requires that a reference photo is prepared in the contact information in advance, then, faces in a photo of multiple persons are matched with the reference photo in the contact information, and if the matching is successful, an area ID is associated with a corresponding contact.

In another matching method, a user manually sets an association.

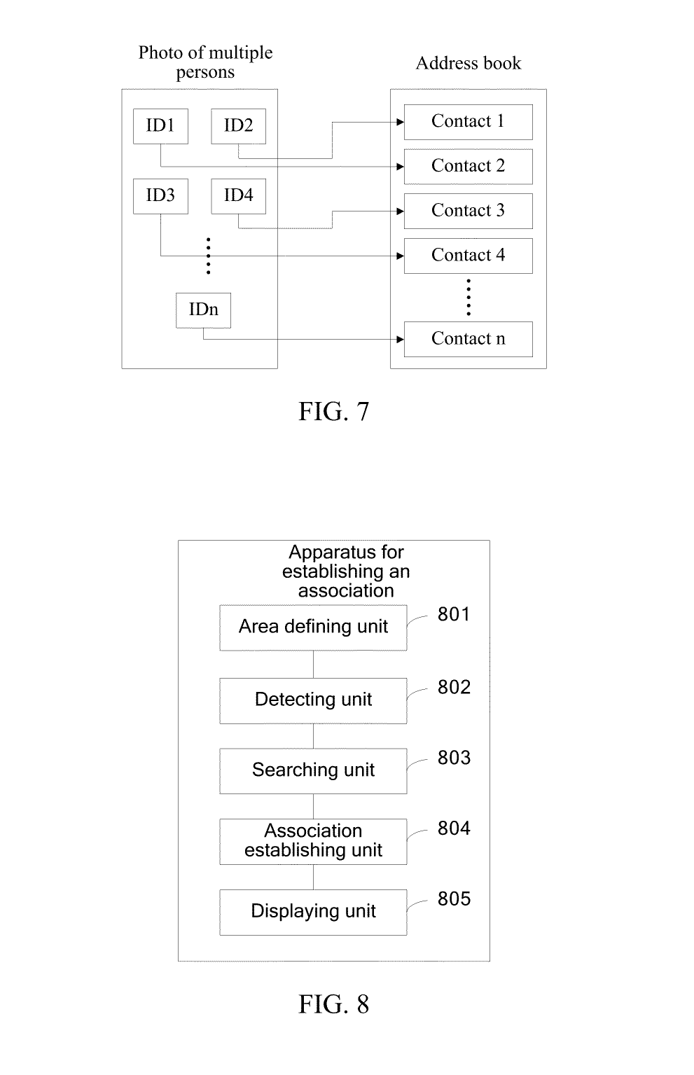

Referring to FIG. 7, the user manually selects a face in a picture/photo of multiple persons, then calls an address book by using a menu, and manually selects a corresponding contact. In this way, an area ID of the face can also be associated with a corresponding contact in the address book. The operation continues to be performed in this manner, and each person in the photo can be associated with a corresponding contact in the address book.

305: Information of the selected person can be displayed by clicking the image of the selected person; or an image of a person corresponding to personal information can be displayed by clicking the personal information.

For example, an association of a picture/photo of multiple persons in a cell phone is established, and after the association of the picture/photo of multiple persons is completed, when a user calls the picture/photo of multiple persons again and clicks, with a finger, an image of a person to be contacted, an area ID of a face at which the finger is pointed can be known in this case, then a contact person in the address book can be found according to the ID, and information, such as contact information of the contact, can be quickly called. Similarly, when personal information is clicked, an image of a person corresponding to the personal information can be displayed.

In addition, when it is intended to find a photo according to a contact, first, all pictures/photos associated with the contact are displayed in the form of thumbnails. Then, a picture/photo of multiple persons that is intended to be seen is selected. The picture/photo of multiple persons is zoomed in for display, and an area of a face area ID associated with the contact is highlighted. In this way, an image of the contact can be visually and quickly found in the photo of multiple persons.

In this way, after an association is completed, when an image of a certain person is clicked, information material of the clicked person can be displayed, or when material of a certain person is clicked, image information of the clicked person can be displayed.

With the foregoing technical solution, after an operation that a user selects an image of a certain person is detected, information matching the image of the selected person is searched for, and then an association between the information matching the image of the selected person and the image of the selected person is established. Compared with the prior art in which a picture only has one file name, the file name is the only basis for identifying the picture, and establishment of an association between specific information of each person in a picture of multiple persons and an image of the person is not supported, with the technical solution provided in the embodiment of the present invention, an association between an image of each person in a picture of multiple persons and information of the person can be established.

Based on the apparatus for establishing an association according to Embodiment 2, as shown in FIG. 8, a fourth embodiment (Embodiment 4) further provides an apparatus for establishing an association. This embodiment includes an area defining unit 801, a detecting unit 802, a searching unit 803, an association establishing unit 804, and a displaying unit 805.

The area defining unit 801 is configured to define an image of each person in a picture/photo of multiple persons as an area and allocate an area ID to each area.

Further, the area defining unit is further configured to define the image of each person in the picture as an area by using a method of facial recognition.

The detecting unit 802 is configured to detect an operation of selecting an image of a certain person.

The searching unit 803 is configured to search for information matching the image of the selected person.

Further, the searching unit is further configured to search for an image that matches the image of the selected person among images provided by a terminal, where the image that matches the image of the selected person among the images provided by the terminal corresponds to to-be-associated information.

The association establishing unit 804 is configured to establish an association between the found information matching the image of the selected person and the image of the selected person.

Further, the association establishing unit is further configured to establish an association between the to-be-associated information and a target area ID. The to-be-associated information corresponds to the image that matches the image of the selected person among the images provided by the terminal, and the target area ID is an area ID of an area where the image of the selected person is located.

Further, the association establishing unit is further configured to, according to a selection manually by a user, establish the association between the to-be-associated information and the target area ID. The to-be-associated information corresponds to the image that matches the image of the selected person among the images provided by the terminal, and the target area ID is the area ID of the area where the image of the selected person is located.

Moreover, the apparatus provided in this embodiment further includes the displaying unit 805, which is configured to display information of the selected person when the image of the selected person is clicked and/or to display an image of a person corresponding to personal information when the personal information is clicked.

Specifically, the area defining unit 801 uses a facial recognition technology to define a face area of each person in a picture/photo of multiple persons, and allocate an area ID for each face area. When the detecting unit 802 detects that a user selects an image of a certain person in the picture/photo, a corresponding area ID is known. The searching unit 803 searches for information matching the image of the selected person. The association establishing unit 804 establishes an association between the found information matching the image of the selected person and the image of the selected person; and after the association is established. The displaying unit 805 displays information of the selected person when the image of the selected person is clicked or displays an image of a person corresponding to personal information when the personal information is clicked.

It should be noted that this apparatus is a specific application of the method, and for a detailed description, reference is made to a related description in Embodiment 3.

The embodiment of the present invention is mainly applied to establish an association between an image of each person in a picture/photo of multiple persons and information of the person when an association is established between an image and information.

With the foregoing technical solution, after an operation that a user selects an image of a certain person is detected, information matching the image of the selected person is searched for, and then an association between the information matching the image of the selected person and the image of the selected person is established. Compared with the prior art in which a picture only has one file name, the file name is the only basis for identifying the picture, and establishment of an association between specific information of each person in a picture of multiple persons and an image of the person is not supported, with the technical solution provided in the embodiment of the present invention, an association between an image of each person in a picture of multiple persons and information of the person can be established. After the association is completed, when an image of a certain person is clicked, information material of the clicked person can be displayed, or when material of a certain person is clicked, image information of the clicked person can be displayed.

A person of ordinary skill in the art may understand that all or a part of the steps of the foregoing embodiments may be implemented by hardware or a program instructing relevant hardware. The program may be stored in a computer readable storage medium. The storage medium may include a read-only memory, a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the claims.

What is claimed is:

1. A method for use with a mobile device, the method comprising:
in response to an operation by a mobile device user, determining an image of a selected person in a picture displayed on the mobile device, the picture including more than one person;
searching for corresponding information that matches the image of the selected person in the picture; and
establishing an association between the image of the selected person in the picture and the corresponding information.

2. The method according to claim 1, wherein before searching for the corresponding information, the method further comprises:
defining an area for an image of each person in the picture; and
allocating an area ID to each area.

3. The method according to claim 2, wherein searching for the corresponding information comprises:
searching for an image provided by the mobile device and that matches the image of the selected person; and
acquiring information associated with the matched image provided by the mobile device.

4. The method according to claim 3, wherein establishing the association between the image of the selected person in the picture and the corresponding information comprising:
acquiring a target area ID, wherein the target area ID is an area ID corresponding to the image of the selected person in the picture;
establishing an association between the information associated with the matched image provided by the mobile device and the target area ID; and
establishing the association between the image of the selected person in the picture and the corresponding information via the target area ID.

5. The method for establishing an association according to claim 2, wherein establishing the association between the image of the selected person in the picture and the corresponding information comprises:
acquiring a target area ID, wherein the target area ID is an area ID corresponding to the image of the selected person in the picture;
according to a selection instruction by a user, acquiring an image provided by the mobile device matches the image of the selected person in the picture;
acquiring information associated with the matched image provided by the mobile device;
establishing an association between the information associated with the matched image provided by the mobile device and the target area ID; and
establishing the association between the image of the selected person in the picture and the corresponding information via the target area ID.

6. The method according to claim 2, wherein defining the area for the image of each person in the picture comprises defining and area for an image of each person in the picture in a manner of a facial recognition.

7. The method according to claim 1, wherein after establishing the association between the image of the selected person in the picture and the corresponding information, the method further comprises:
obtaining an instruction that a user has selected an image of a selected person in the picture; and
displaying the corresponding information.

8. The method according to claim 1, wherein after establishing the association between the image of the selected person in the picture and the corresponding information, the method further comprises:
obtaining an instruction that a user has selected the information; and
displaying an image corresponding to the information.

9. A mobile device for establishing an association between an image of at least one person in a picture of multiple persons and a corresponding information of the at least one person comprising:
a display unit;
a memory;
a processor coupled to the memory, wherein the processor is configured to:
determine an image of a selected person in a picture displayed on the display unit in response to an operation by a user;
search for corresponding information that matches the image of the selected person in the picture; and
establish an association between the image of the selected person in the picture and the corresponding information.

10. The mobile device according to claim 9, the processor is further configured to:
define an area for an image of each person in the picture before the search for the corresponding information; and
allocate an area ID to each area.

11. The mobile device according to claim 10, wherein the processor is configured to search for the corresponding information by:
searching for an image provided by the mobile device that matches the image of the selected person; and
acquiring information associated with the matched image provided by the mobile device.

12. The mobile device according to claim 11, wherein the processor is configured to establish the association between the image of the selected person in the picture and the corresponding information by:
acquiring a target area ID, wherein the target area ID is an area ID corresponding to the image of the selected person in the picture;
establishing an association between the information associated with the matched image provided by the mobile device and the target area ID; and
establishing the association between the image of the selected person in the picture and the corresponding information via the target area ID.

13. The mobile device according to claim 10, wherein the processor is configured to establish the association between the image of the selected person in the picture and the corresponding information by:
acquiring a target area ID, wherein the target area ID is an area ID corresponding to the image of the selected person in the picture;
acquiring an image provided by the mobile device that matches the image of the selected person in the picture according to a selection instruction by a user;
acquiring information associated with the matched image provided by the mobile device;
establishing an association between the information associated with the matched image provided by the mobile device and the target area ID; and
establishing the association between the image of the selected person in the picture and the corresponding information via the target area ID.

14. The mobile device according to claim 10, wherein the processor is configured to define the area for the image of each person in the picture by defining an area for an image of each person in the picture in a manner of a facial recognition.

15. The mobile device according to claim 9, the display unit is configured to display corresponding information after establishing the association between the image of the selected person in the picture and the corresponding information and when the processor obtains an instruction that the user has selected the image of a selected person in the picture.

16. The mobile device according to claim 9, the display unit is configured to display an image corresponding to the information after establishing the association between the image of the selected person in the picture and the corresponding information, the image displayed when the processor obtains an instruction that the user has selected information.

17. The mobile device according to claim 9, wherein the picture comprises a photograph.
